(19) United States
(12) Patent Application Publication
(10) Pub. No.: US 2023/0227182 A1
(43) Pub. Date: Jul. 20, 2023

(54) AERIAL RECONNAISSANCE DRONE AND METHOD

(71) Applicant: The Secretary of State for Defence, Salisbury, Wiltshire (GB)

(72) Inventor: Paul Kimber, Salisbury (GB)

(73) Assignee: The Secretary of State for Defence, Salisbury, Wiltshire (GB)

(21) Appl. No.: 18/001,983

(22) PCT Filed: Jun. 8, 2021
(86) PCT No.: PCT/GB2021/000065

§ 371 Date: Dec. 15, 2022

(30) Foreign Application Priority Data
Jul. 2, 2020 (GB) 2010412.1

(51) Int. Cl. B64U 10/40; B64C 33/02; B64U 20/87; G05D 1/00

(52) U.S. Cl. CPC B64U 10/40; B64C 33/02; B64U 20/87; G05D 1/0038; B64U 2201/20; B64U 2101/30

(57) ABSTRACT

An aerial reconnaissance drone having a dragonfly format (elongate fuselage and flapping wings) with two cameras having respective diagonal fields of view, arranged at respective ends of the fuselage, both pointing forwards, wherein the second camera has a diagonal fielder of view that is at most half that of the first camera. This has the advantage of providing a drone that can capture enhanced imagery when required, by performing a half turn and switching which camera is being used. Since this avoids placing two cameras in the same location both can have a clear view of surroundings yet it helps avoid off balance caused by placing too much mass in any particular off-centre location.

The present invention relates to the field of reconnaissance aerial drones.

Many aerial drones exist, such as quadcopters, often with cameras, some with multiple cameras. Drones with multiple cameras typically fall into the categories of those with stereoscopic identical cameras, arrays of cameras providing a 360 degree field of view, or two forward facing cameras having the same direction but differing fields of view. Aerial drones can have several formats, commonly fixed wing and quadcopter. Birdlike and dragonfly drones are far less common.

It is an object of the present invention to provide an improved lightweight reconnaissance drone.

According to a first aspect of the present invention there is provided a drone having an elongate fuselage and four wings arranged to provide lift by flapping, and first and second cameras having respective diagonal fields of view, wherein the first camera is arranged at a front end of the fuselage, pointing forwards, and the second camera is arranged at the rearward end of the fuselage, pointing rearwards, and wherein the second camera has a diagonal field of view that is at most half that of the first camera.

This has the advantage of providing a drone that can capture enhanced imagery when required. Since this approach avoids placing two cameras in the same location both can have a clear view of surroundings yet it helps avoid off balance caused by placing too much mass in any particular off-centre location.

Preferably the drone is provided with a remote control unit, and the drone and remote control unit are configured such as to present the user with a user interface option to switch to enhanced imagery, wherein the drone and remote control unit are configured such that upon selection of this option by the user, the drone performs a half turn (about a vertical axis) in use, and transmission of imagery from the first camera to the remote control unit, is replaced with transmission of imagery from the second camera. Generally the control unit also has an option to switch back, and the drone and remote control unit are configured to perform the opposite operation in response to selection of such option.

According to a second aspect of the present invention there is provided a method of using a drone comprising the steps of:
providing a drone having an elongate fuselage and four wings arranged to provide lift by flapping, and first and second cameras having respective diagonal fields of view, wherein the first camera is arranged at a front end of the fuselage, pointing forwards, and the second camera is arranged at the rearward end of the fuselage, pointing rearwards, and wherein the second camera has a diagonal field of view that is at most half that of the first camera;
providing a remote control unit having a user interface, and providing to a user an option to switch to an enhanced imagery mode, wherein the remote control unit and drone are adapted such that in the event that the user selects the option to switch to the enhanced imagery mode, the drone performs a half turn about a vertical axis, and switches from providing imagery from the first camera of the drone to the remote control unit, to providing imagery from the second camera of the drone to the remote control unit.

Preferably the remote control unit has a screen, having a view corresponding substantially to the field of view of the first camera, and shows a marking (E.g. a box or suchlike) to indicate the field of view of the second camera if the drone were to turn around 180 degrees. The remote control has a user interface control (E.g. button) to cause the drone to rotate so that the 2^{nd} camera points to show the area that was marked (e.g. by the box).

Optionally this box is movable via a user interface, so that the user can move it to specify a viewing direction of interest, prior to activating the control (E.g. button), and in this case the drone rotates so as to point the second camera to correspond to the marker (e.g. box) within the first camera's field of view.

Generally the control unit has a screen for displaying the imagery, and display the imagery to the user via the display, however alternatively such imagery may be stored or forwarded as required by the user.

Note that the camera(s) do not necessarily have to be at the same height as the body of the drone, and could be mounted on top of the drone. Similarly it is not strictly necessary for a camera to be the end of the drone, but should be mounted at (i.e. in the vicinity of) the end of the drone. This is particularly true of camera with the smaller field of view. Depending on the relative weight of the cameras and placement of other components e.g. batteries, it may be desirable to position the cameras somewhat proud or short of the respective end of the drone body. If the cameras are not at the same height in use during level flight (noting that a flapping wing drone can typically tilt somewhat — enabling pointing of the cameras), for example if one camera is above the body during level flight, and the other camera is below the body, then it is advantageous that as the drone rotates it also adjusts its altitude so that the viewing point of the newly selected camera matches the viewing point that the previously used camera previously had. Additionally, if the drone is tilting down or up, an altitude adjustment is preferably made to ensure that the newly selected camera then has the same viewpoint/vantage as the previously selected camera did.

Preferred embodiments will be described by way of example only, with reference to the figures in which:

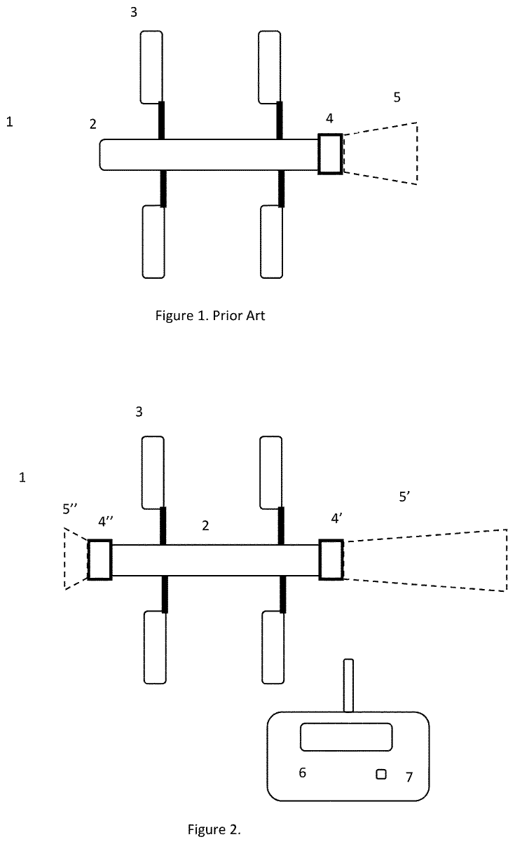

FIG. 1 shows a side view of a known dragonfly style drone; and

FIG. 2 shows a side view of a drone according to an embodiment of the invention, with a remote control unit.

Referring to FIG. 1 a dragonfly style drone is shown. It has two wings either side of an elongate fuselage, and a single camera at the front.

FIG. 2 shows an embodiment of the present invention. By comparison with the prior art drone of FIG. 1, it has one camera at either end of the fuselage, each pointing outwards. The cameras have differing fields of view (measured diagonally with respect to a square/rectangular image sensor within each camera). The cameras may not have identical resolutions, but the angular resolution of the second camera is generally smaller than the angular resolution of the larger camera. In general the focal length of the second camera is longer than that of the first camera, typically by a factor of at least two.

Generally the fields of view are fixed (barring any small changes caused by focal adjustment), as this offers an advantage in terms of weight reduction and/or light collection. However if they are not fixed (e.g. in the case of zoom lenses) the smallest available field of view achievable that can be automatically (rather than manually) adjusted to during use should be taken as the field of view of that camera. For example the first camera preferably has a diagonal field of view of between 80 and 230 degrees, preferably of between 90 and 150 degrees. And the second camera preferably has a diagonal field of view of between 1 and 80 degrees preferably between 2 and 50 degrees, preferably between 3 and 20 degrees.

Generally speaking there is provided an aerial reconnaissance drone having a dragonfly format (elongate fuselage and flapping wings), with two cameras 4′, 4″ having respective diagonal fields of view 5′, 5″, arranged at respective ends of the fuselage, both pointing forwards, wherein the second camera has a diagonal field 5″ of view that is at most half that 5′ of the first camera 4′.

In any embodiment preferably one or both cameras is a mirror-lens camera wherein substantially each of the optical elements of the lens is a mirror. A mirror lens is a term of art, and may often contain no lens elements, or may contain one or a small number of lenses, often being small lenses. Preferably the second camera has a mirror lens. The advantage is that a larger amount of light can be collected without increasing the weight of the drone, and this approach particularly suits a drone with two fixed focal length cameras since mirror lenses typically do not adjust focal length or do so only minimally or with severe detrimental tradeoffs.

In any embodiment preferably at least one of the cameras is also an illuminator. Preferably this is achieved by incorporating a light emitting array (E.g. LED's) as a front layer of the sensor, such that the sensor can direct light via the respective lens so as to be collimated to be directed in one or more controlled (E.g. user-defined via the GUI, or automatically selected) directions. Preferably the light emitting array substantially overlies the whole sensor, such that the camera can illuminate in any direction that it can view. Viewing and illumination may not be possible at the same time, however it is preferably possible to illuminate in pulses of light, between image frames collected by the sensor, so that the illuminator and image recording can occur alternately.

1. An aerial reconnaissance drone apparatus comprising:
an aerial drone comprising an elongate fuselage and four wings arranged to provide lift by flapping, and first and second cameras having respective square/rectangular fields of view and respective diagonal field of view angles, wherein the first camera is arranged at a front end of the fuselage, pointing forwards, and the second camera is arranged at a rearward end of the fuselage, pointing rearwards, and wherein the second camera has a diagonal field of view angle that is at most half of a diagonal field of view angle of the first camera; and
a remote control unit configured to wirelessly transmit instructions to the aerial drone and receive imagery therefrom, wherein the aerial drone is configured to move as instructed and to transmit imagery back, and wherein the remote control unit comprises a user interface comprising a display configured to display such imagery,
wherein the remote control unit is arranged to provide a user with an option to switch between two imagery modes, wherein the remote control unit and drone are arranged such that upon selection, the drone rotates as to substantially reverse orientations of the cameras and the display switches from displaying imagery from one camera to displaying imagery from the other camera, and, wherein the second camera has a diagonal field of view width that is at most half that of the first camera.

2. The aerial reconnaissance drone of claim 1, wherein the first camera has a diagonal field of view angle of between 80 and 230 degrees, and the second camera has a diagonal field of view angle of between 1 and 80 degrees.

3. The aerial reconnaissance drone of claim 1, wherein the first camera is an illuminator.

4. The aerial reconnaissance drone of claim 1, wherein the second camera comprises a mirror element.

5. A method of using a drone for aerial reconnaissance, the method comprising:
providing an aerial drone comprising an elongate fuselage and four wings arranged to provide lift by flapping, and first and second cameras having respective square/rectangular fields of view and respective diagonal field of view angles, wherein the first camera is arranged at a front end of the fuselage, pointing forwards, and the second camera is arranged at the rearward end of the fuselage, pointing rearwards, and wherein the second camera has a diagonal field of view angle that is at most half that of the first camera; and
providing a remote control unit configured to wirelessly transmit instructions to the drone and receive imagery therefrom, wherein the drone is configured to move as instructed and to transmit imagery back, and wherein the remote control unit comprises a user interface comprising a display configured to display such imagery, wherein the remote control unit is arranged to provide a user with an option to switch between two imagery modes, wherein the remote control unit and drone are arranged such that upon selection, the drone rotates so as to substantially reverse the orientations of the cameras and the display switches from displaying imagery from one camera to displaying imagery from the other camera, and, wherein the second camera has a diagonal field of view width that is at most half that of the first camera; and
selecting the option to switch between two imagery modes, the drone performing a half turn, and the display switching from displaying imagery from one camera, to displaying imagery from the other camera.
